(19) United States
(12) Patent Application Publication
(10) Pub. No.: US 2011/0123968 A1
(43) Pub. Date: May 26, 2011

(54) HAND-HELD EDUCATIONAL GAME

(76) Inventor: Corey John McLaughlin, Omaha, NE (US)

(21) Appl. No.: 12/625,458

(22) Filed: Nov. 24, 2009

(51) Int. Cl. G09B 23/02; G09B 23/06

(52) U.S. Cl. 434/188; 434/300

(57) ABSTRACT

A hand-held educational game includes: a transparent container having an inner surface; a receptacle on the inner surface; a text message on the inner surface associated with the receptacle; and an object, moveable by the user, adapted to associate with the receptacle. The user views the device and text through the container and manipulates the container so as to associate the object with the receptacle.

### BACKGROUND OF THE INVENTION

The present invention generally relates to teaching devices, and more specifically, to a hand-held educational game.

Too many kids are not learning about science and math. Also, too many of the injured and elderly are not getting the exercise and treatment they need. And, there's just not enough good clean fun out there that can entertain any time, anywhere. No batteries required.

Learning and exercise are best absorbed whence they are fun and challenging.

As can be seen, there is a need for a hand-held game that teaches math and physics.

### SUMMARY OF THE INVENTION

In one aspect of the present invention, a device for a user includes: a transparent container having an inner surface; a receptacle on the inner surface; a text message on the inner surface associated with the receptacle; and an object, moveable by the user, adapted to associate with the receptacle; wherein the user views the device and text through the container and manipulates the container so as to associate the object with the receptacle.

In another aspect of the present invention, a device for a user to identify a text includes: a transparent container; a plurality of targets on the container; educational text associated with the targets; and an indicator, within the container, adapted to be manipulated by the user to traverse between the targets; wherein the user manipulates the container to associate the indicator with the targets, thereby identifying the associated text.

In yet another embodiment of the present invention, a method for associating rules with a device utilized by a user includes: providing a container to be held by hands of the user; displaying, on an inner surface of the container, rules; providing, within the container, a target associated with the rules; and manipulating the device to move the object to the target, thereby associating the rules with the device.

These and other features, aspects and advantages of the present invention will become better understood with reference to the following drawings, description and claims.

### BRIEF DESCRIPTION OF THE DRAWINGS

FIG. 1 depicts an embodiment of the present invention;

FIG. 2 depicts a side view of an embodiment of the present invention;

FIG. 3 depicts a bottom view of an embodiment of the present invention;

FIG. 4 depicts an embodiment of a target attachment according to the present invention;

FIG. 5 depicts an embodiment of a removable target according to the present invention; and

FIG. 6 depicts a appliqués according to the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a device for amusement, education, and both physical and mental therapy that may be fun and challenging.

In an embodiment of the present invention, physics and mathematical concepts are defined inside a clear sphere, held in the user's hands. The applicable equations including definitions are noted on appliqués adhered to the inside of the sphere. Inside the sphere are relocatable targets with a maneuverable object ball. The user manipulates the sphere to make the object ball traverse from target to target, thereby demonstrating the applicable physics equations. This may be both mentally and physically exertive and beneficial. The “object ball” may be a physical ball retained with the sphere of the invention, or it may be another physical object, or it may be a virtual (e.g. software-generated) object. The user manipulates the orientation and position of the embodiment with his hands so as to drive the object ball into the targets, e.g. by utilizing gravity and momentum to impel an article into one or more cups or apertures.

An embodiment of the invention may be adaptable, useful as a tool of education, and, provide both physical and therapeutic exercise.

An embodiment may improve the ability of a teacher to cause children to become interested in math and science. It may also be a method of physical exercise via a fun and challenging activity. Also, it may be effective as an occupational health device for re-learning.

Elements of an embodiment may include a clear sphere approximately 9 to 10 inches in diameter with holes in 8 rows of 4. Removable and varyingly sized hollow targets with differing heights and weights are made of colorful plastic and mounted inside the sphere. An object ball of different sizes and composition is directed from one target to another via finger tap, a tumble, a hop, a flip, or a roll. This device is scalable. Within the sphere is an applique of the equations of the physics occurring. Larger or lighter object balls are directed by a user, thus encouraging physical activity and cognition.

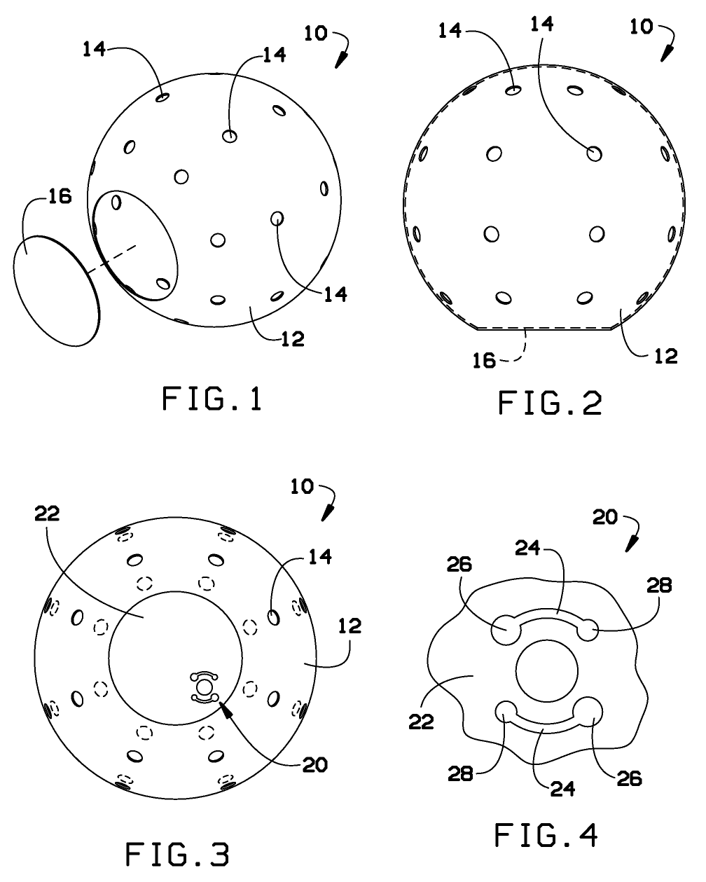

FIGS. 1 and 2 depict an embodiment 10 of the present invention including a sphere 12, with a plurality of target apertures 14, and a removable lid 16.

FIG. 3 depicts an embodiment 10 with the lid removed, showing a target attachment 20 on the inner surface 22 of the sphere 12.

FIG. 4 depicts an embodiment of a target attachment 20 including a pair of slots 24 on the inner surface 22, each having a receiving bulge 26 and a retaining bulge 28. The slots 24 generally follow an arc of a circle around the target aperture 14. The receiving bulge 26 is wider than the retaining bulge 28.

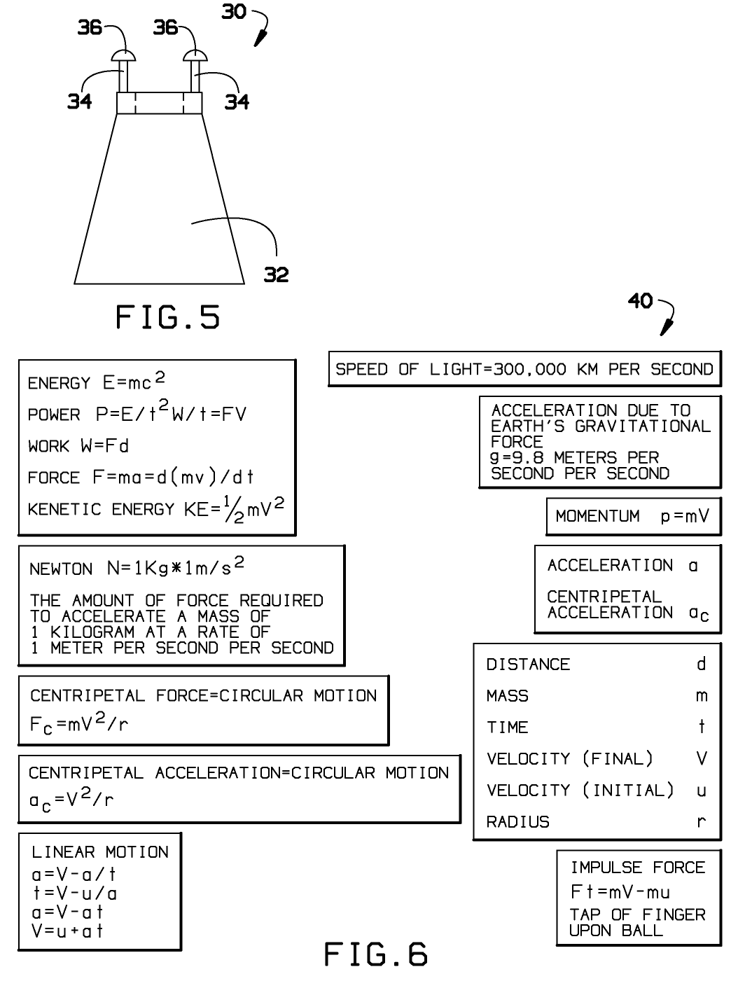

FIG. 5 depicts an embodiment of a target 30 having a cup 32, to receive the object ball, and two attachment shafts 34 attached to the base of the cup, each with attachment knobs 36. The cup also has a ball aperture 38 in the base of the cup, between the shafts 34.

In the embodiment of FIGS. 4 and 5, a user may attach a removable target 30 by inserting the knobs 36 into the receiving bulges 26, and rotating the target 30. The shafts 34 will slide along the slots 24 into the retaining bulges 36, and this will also align the ball aperture 38 with the target aperture 14 on the inner surface 22.

FIG. 6 depicts embodiments of appliqués 40 that may be applied to the sphere. An appliqué 40 may be a sticker or other mechanism for associating text or graphics with the targets, either on the inner or outer surface of the sphere.

In an alternate embodiment, software may be developed and implemented to project images to simulate the physical activities occurring within the sphere.

In embodiments, as many, or as few targets may be used, one of which may be a U-turn. Balls of differing mass and diameter are used to achieve different results. This device educates, and or, encourages physical exertion. Including physical rehabilitation.

To use an embodiment, extend arms fully, and hold the sphere in the user's hands, one on top and one on the bottom. Twist the sphere 180 degrees, or 90 degrees, or something in between, taking care to direct the object ball from target to target. The user may manipulate the ball via any physical mechanism, including: hop finger tap, tumble, hop, flip, roll, or other. Embodiments may include magnets. The ball also demonstrates centripetal force.

In an embodiment, the targets within this sphere are removable and differ in size. The object ball may differ greatly also. The targets channel the smaller object balls to the spheres wall where the ball protrudes. Tapping the ball projects it another target, or you can tumble a larger object ball.

An embodiment may be made utilizing plastic via molds.

An embodiment may be reconfigured. The targets may be coordinated between two or more spheres to encourage a competitive atmosphere. The targets of roughly ¾″ to 2.5″ may be assigned differing point values to score a game.

An embodiment may be used to educate children about physics; to entertain/kill time; to encourage exercise of the upper body; to offer rehabilitation of the hands/fingers; or to improve hand-eye coordination.

An embodiment may be used in K-12 schools, care centers for the elderly, physical therapy offices, or anywhere someone may have time on their hands.

It should be understood, of course, that the foregoing relates to exemplary embodiments of the invention and that modifications may be made without departing from the spirit and scope of the invention as set forth in the following claims.

We claim:

1. A device for a user, comprising:
a transparent container having an inner surface;
a receptacle on the inner surface;
a text message on the inner surface associated with the receptacle; and
an object, moveable by the user, adapted to associate with the receptacle;
wherein the user views the device and text through the container and manipulates the container so as to associate the object with the receptacle.

2. The device of claim 1, wherein:
the container is adapted to be held in hands of the user, and manipulated by the hands to direct the object to the receptacle.

3. The device of claim 1, wherein:
the container is a sphere.

4. The device of claim 1, wherein:
a portion of the object extends outside of the container, and the user taps the object thereby urging the object to associate with the receptacle.

5. The device of claim 1, wherein:
the text relates to physics and mathematics associated with the movement of the object to the receptacle.

6. The device of claim 1, wherein:
the receptacle is a virtual receptacle provided by a computer program;
the text is virtual text provided from the program; and
the object is a virtual object provided by the program;
wherein the program provides the user with a view of the receptacle, the text, and the object, and the user may manipulate the container to associate the object with the receptacle.

7. The device of claim 1, further comprising:
a slot on the inner surface of the container adapted to releasably engage with the receptacle;
wherein the receptacle can be attached and released utilizing the slot.

8. A device for a user to identify a text, comprising:
a transparent container;
a plurality of targets on the container;
educational text associated with the targets; and
an indicator, within the container, adapted to be manipulated by the user to traverse between the targets;
wherein the user manipulates the container to associate the indicator with the targets, thereby identifying the associated text.

9. A method for associating rules with a device utilized by a user, comprising:
providing a container to be held by hands of the user;
displaying, on an inner surface of the container, rules;
providing, within the container, a target associated with the rules; and
manipulating the device to move the object to the target, thereby associating the rules with the device.

10. The method of claim 9, further comprising:
providing a text message on the inner surface associated with the receptacle; and
receiving an identification associated with the object in the target, thereby identifying the rules associated with the container.
